(19) United States
(12) Patent Application Publication
(10) Pub. No.: US 2013/0336117 A1
(43) Pub. Date: Dec. 19, 2013

(54) DISTRIBUTED PROCESSING SCHEME TO SUPPORT IEEE 1588 PTP OVER MULTIPLE PORTS SPANNING A LAG

(71) Applicants: Desmond Yan, Vancouver (CA); Qun Zheng, Surrey (CA)

(72) Inventors: Desmond Yan, Vancouver (CA); Qun Zheng, Surrey (CA)

(21) Appl. No.: 13/524,781

(22) Filed: Jun. 15, 2012

(51) Int. Cl. H04L 12/26

(52) U.S. Cl. 370/235

(57) ABSTRACT

A Precision Timing Protocol (PTP) is implemented over a Link Aggregation Group (LAG) formed by multiple ports of a network node, where PTP traffic goes through the same physical link between the network node and a peer network node on both the transmit and return paths. When the network node receives a PTP message that identifies a PTP stream from the peer network node through a given PTP-LAG port, it declares itself as an active port and the other PTP-LAG ports as standby for the PTP stream. The PTP stream is transmitted from the network node to the peer network node through the active port only, to maintain symmetry of the PTP stream's transmission paths between the network node and the peer network node. The network node processes exchanged messages of the PTP stream to perform timing synchronization with the peer network node.

### FIELD

Embodiments of the invention relate to the field of network operations; and more specifically, to the synchronization of timing information between network nodes.

### BACKGROUND

The IEEE 1588 protocol is a timing distribution protocol that allows network devices to synchronize their time with a grandmaster clock. The IEEE 1588 protocol defines the Precision Timing Protocol (PTP), which involves exchanging protocol messages between a master network node and slave network nodes. The network node uses the exchanged protocol messages to estimate clock differences for adjusting local clocks.

Link Group Aggregation (LAG) is a resiliency technology widely used on Ethernet-based networks. A network node can implement a LAG by grouping a number of its ports together to form a single transport pipe. Traffic is load-balanced among the ports not only to increase bandwidth, but also to provide redundancy against failure. When one of the ports in a LAG fails, traffic will be redistributed to the remaining ports in the same LAG.

Conventionally, a network node implementing the LAG uses a hash algorithm on the packet header content to determine which port in the LAG to transmit traffic. As each network node runs its hash algorithm independently without coordination with its peer network node, it cannot be guaranteed that both transmit and receive traffic land on the same physical port. For example, assume that both router_A and router_B use the same, simple hash algorithm on the [src_IP_addr/dest_IP_addr] tuple. The hashed port ID computed by the two router will still be different because router_A will use [IP A/IP B] while router_B uses [IP B/IP A] to compute the hash, where IP_A represents the Internet Protocol (IP) address of router A and IP_B represents the IP address of router B.

Currently, a PTP clock can only be bound with a physical port, not a logical port group such as the port group in a LAG. This is because for telecom grade precision, current PTP clock synchronization mechanism assumes that protocol messages traverse the same path in both the forward (send) and reverse (reply) directions, so that the propagation delay can be estimated as half the value of the measured round-trip delay. The LAG operation by nature has broken the above assumption, rendering the PTP protocol not feasible.

### SUMMARY

The IEEE 1558 Precision Timing Protocol (PTP) is implemented over a Link Aggregation Group (LAG), where PTP traffic goes through the same physical link between a network node and a peer network node on both the transmit and return paths. The LAG is formed by multiple ports of the network node. The ports in the LAG are coupled to the peer network node via respective links that form a single logical transport pipe to improve load balancing and to provide redundancy.

In one embodiment, a method is performed by a network node for implementing the PTP over a LAG. A PTP-port group is formed for a PTP stream by the ports in the LAG. When the network node receives a PTP message that identifies the PTP stream from the peer network node through a given port in the LAG, it declares to other ports in the LAG that the given port is an active port for the PTP-port group and the other ports are standby ports for the PTP-port group. The network node exchanges messages of this PTP stream to the peer network node through the active port. The PTP stream is transmitted from the network node to the peer network node through the active port only and not through any of the standby ports to maintain symmetry of the PTP stream's transmission paths between the network node and the peer network node. The network node then processes exchanged messages of the PTP stream to perform timing synchronization with the peer network node.

In one embodiment, a network node includes line cards over which the ports in a LAG span. Each of the line cards includes receiver circuitry to receive a PTP message that identifies a PTP stream from the peer network node through a given port in the LAG, transmitter circuitry to transmit messages of the PTP stream, and a processor coupled to the receiver circuitry and the transmitter circuitry. The processor is configured to form A PTP-port group for the PTP stream by the ports in the LAG, declare to other ports in the LAG upon reception of the PTP message that the given port is an active port for the PTP-port group and the other ports are standby ports for the PTP-port group, exchange the messages of this PTP stream to the peer network node through the active port only and not through any of the standby ports to maintain symmetry of the PTP stream's transmission paths between the network node and the peer network node. The processor is also configured to process the exchanged messages of the PTP stream to perform timing synchronization with the peer network node.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 illustrates an embodiment of a network environment in which PTP timing synchronization can be performed.

FIG. 2A illustrates an embodiment of a network node that implements PTP timing synchronization.

FIG. 2B illustrates an embodiment of a line card in the network node of FIG. 2A.

FIG. 3 is a diagram illustrating the mapping between ports and a port group according to an embodiment of the invention.

FIG. 4 is a block diagram illustrating an embodiment a PTP-port group that implements PTP timing synchronization.

FIG. 5 is a flow diagram illustrating an embodiment of a method of establishing a PTP clock over a LAG according to an embodiment of the invention.

FIG. 6 is a flow diagram illustrating an embodiment of a method of re-declaring a standby port as a new active port according to an embodiment of the invention.

### DESCRIPTION OF EMBODIMENTS

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

Embodiments of the invention provide a mechanism that allows the IEEE 1588 PTP protocol to be deployed over a LAG on a network node. The method implements the PTP on a LAG by guaranteeing that network traffic of the same PTP stream goes through the same physical link on the transmit and receive paths. According to embodiments of the invention, for each PTP stream passing through a physical port group that belongs to a LAG, one of the physical ports is declared as the active port for the PTP stream. Other physical ports in the LAG stay dormant (i.e., standby) and listen to the PTP stream. When a diversion of the PTP stream is detected by one of the standby ports, a re-declaration is triggered such that the standby port receiving the PTP stream becomes the new active port, thereby re-anchoring the PTP stream to the new active port.

Embodiments of the invention allow the IEEE 1588 PTP protocol to be deployed over a LAG, such that a network node can benefit from the resiliency offered by the LAG while supporting the PTP timing synchronization.

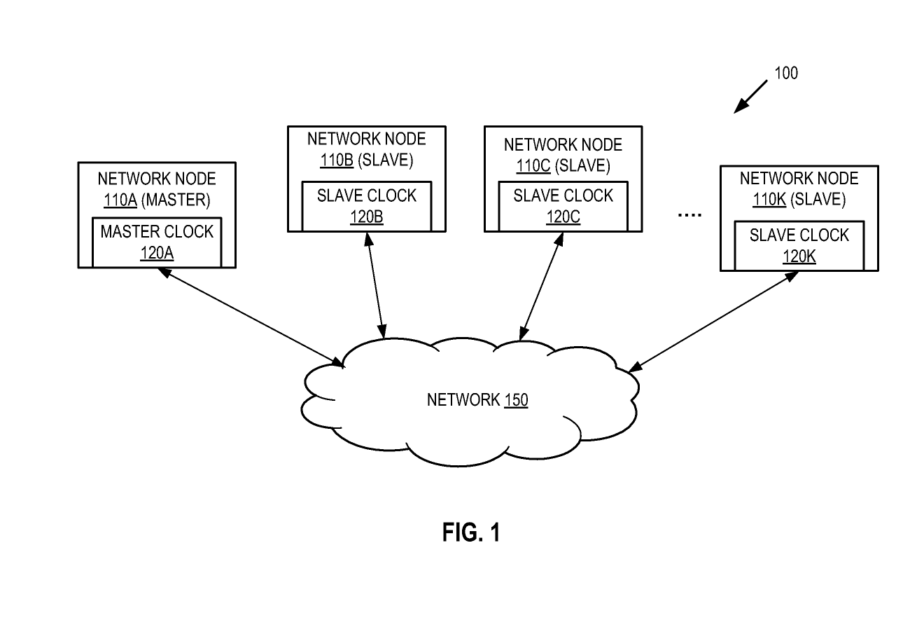

FIG. 1 illustrates a network environment 100 in which embodiments of the invention may operate. The network environment 100 includes multiple network nodes 110A-K coupled to a network 150. The network nodes 110A-K maintain respective clocks of different precision, resolution and stability. Each network node 110A-K can exchange PTP communications with the other network nodes in the network 100 to synchronize their local clocks. The network 150 may be a local area network (such as, but not limited to, an Ethernet network), or any network that supports the IEEE 1588 PTP protocol.

According to the IEEE 1588 PTP protocol, one of the network nodes (e.g., 110A) maintains a master clock 120A and the other network nodes (e.g., 110B-K) maintain respective slave clocks 120B-K. The master clock 120A and the slave clocks 120B-K are on communication paths via which PTP messages are exchanged. All of the slave clocks 120B-K are synchronized to the master clock 120A. For the purpose of PTP communications, these network nodes 110A-K are referred to as the “peer network nodes” or “peer nodes.” The master clock 120A is synchronized to a grandmaster clock (not shown), which is the source of synchronization in a clock synchronization domain in which all of the clocks are synchronized to each other. In one embodiment, the grandmaster clock may be the master clock 120A or another clock maintained by a network node coupled to the network 150.

In one embodiment, the network nodes 110A-K synchronize their clocks by performing an end-to-end delay measurement between the master clock 120A and the slave clock 120B-K. For example, a slave clock can send a time-stamped PTP message to a master clock, and waiting for a time-stamped PTP reply message from the master clock. A round trip time between the two clocks, as calculated by using the time stamps in the messages, can be used to adjust the slave clock so that it is synchronized to the master clock.

According to embodiments of the invention, one or more of the network nodes 110A-K implement the LAG such that multiple physical ports of the network node form a LAG group (or “LAG”). Thus, this LAG group is capable of supporting the PTP communications between the peer nodes.

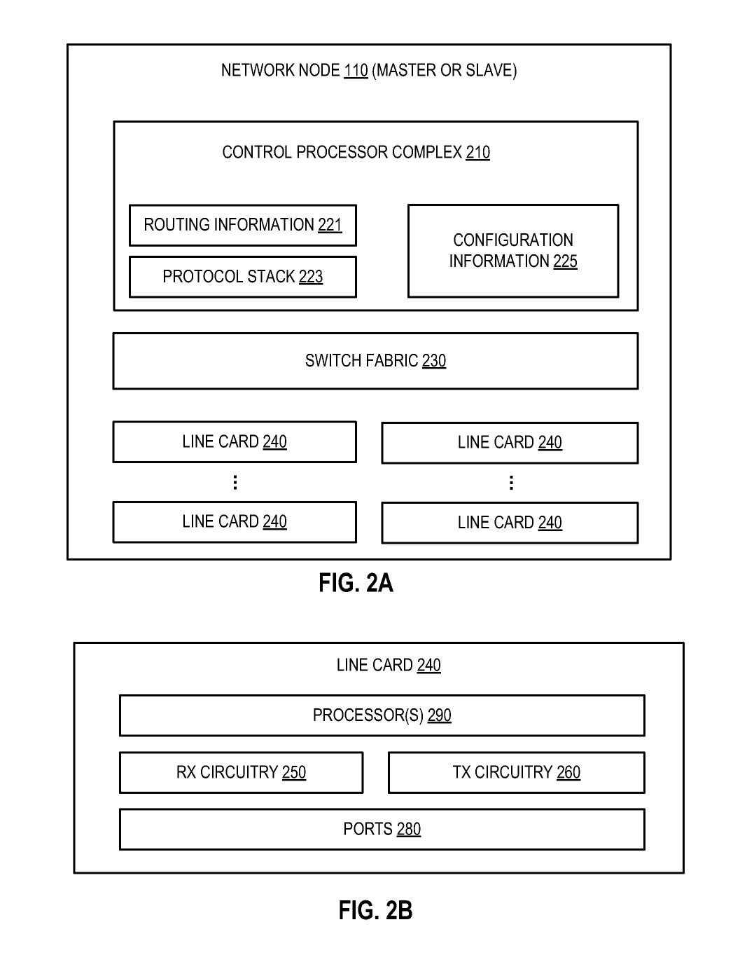

FIG. 2A illustrates an example of network node 110 that may be used to implement an embodiment of the invention. FIG. 2B illustrates an example of a line card 240 within the network node 110. The network node 110 may be any of the network nodes 110A-K described above. In one embodiment, the network node is a router.

As shown in FIGS. 2A and 2B, the network node 110 includes a data plane, which further includes a switching fabric 230 and a number of line cards 240. Each line card 240 includes one or more processors 290, receiver (Rx) circuitry 250, transmitter (Tx) circuitry 260 and multiple ports 280. The Rx and Tx circuitry 250 and 260 interface with links in the network through the ports 280. The line cards 240 perform functions on data received over the circuitry 250, and the switching fabric 230 switches data between the line cards to be egressed out the network node 110 through 260.

The network node 110 also includes a control plane, which is shown as a control processor complex 210. The control processor complex 210 supports the management and signaling control of the LAG described above. In one embodiment, the control processor complex 210 contains control circuitry configured to handle the routing, forwarding, and processing of the data traffic. The control processor complex 210 also stores routing information 221 indicating where to forward traffic incoming to the network node 110, a protocol stack 223 for handling various protocols, and various configuration information 225. It is understood that the network node 110 may include additional components and information than what is described above.

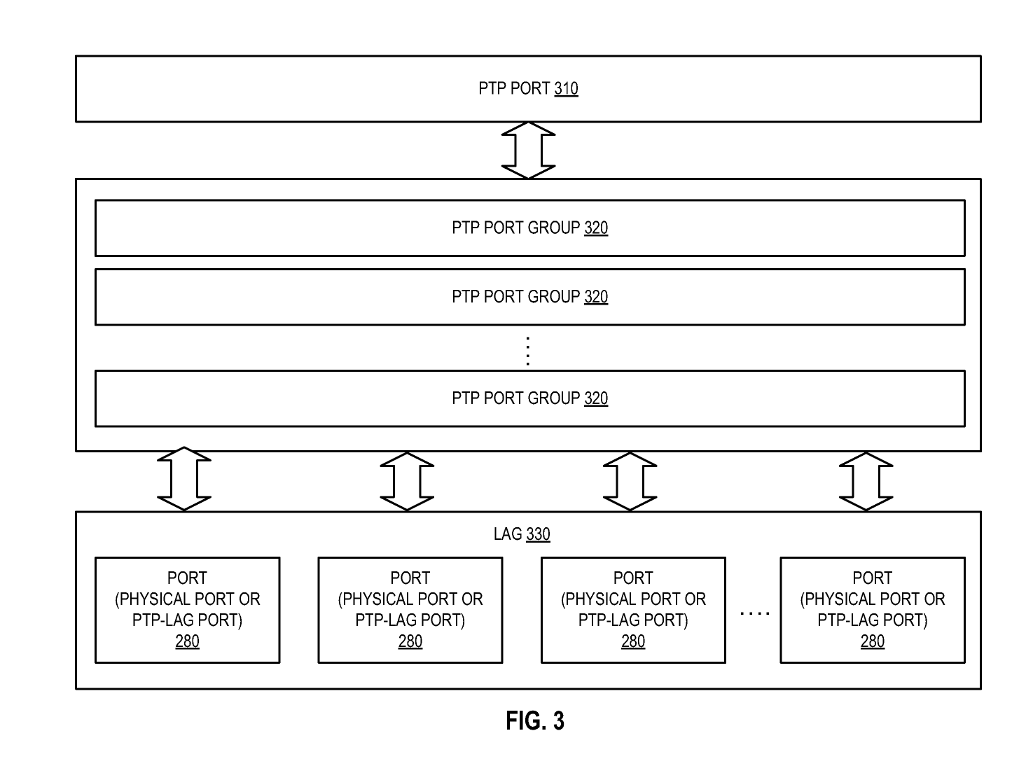

Before describing further details of embodiments of the invention, some terminology is explained first with reference to the diagram of FIG. 3.

PTP port 310—according to IEEE 1588 protocol, a PTP port 310 is a logical entity that provides an end point for a PTP protocol communication pair to exchange PTP messages, thereby allowing peer PTP clocks to address the local PTP clock. Each PTP port 310 could contain more than one PTP stream.

PTP-port group 320—a PTP logic entity that spans over all of the physical ports in a LAG 330. A PTP-port group 320 is purely internal to the individual network node. From the network's point of view, a PTP-port group 320 is the same as the PTP port 310 defined in the IEEE 1588 protocol, which provides an end point for a PTP protocol communication pair to exchange PTP messages, thereby allowing peer PTP clocks to address the local PTP clock. For simplicity of the illustration, FIG. 3 shows only one PTP-port group over the LAG 330. However, in some scenarios multiple PTP-port groups may span over the same LAG 330. Each PTP-port group 320 supports a single PTP stream.

Port 280—a port 280 as used herein is a physical port unless otherwise specified. A port 280 that supports PTP and is part of a LAG is also referred to as a PTP-LAG port. Multiple ports 280 form a LAG.

PTP stream—according to the IEEE 1588 protocol, a PTP stream is identified by its local and remote PTP ports, which are the two communication end points. Conventionally, there is a hidden assumption that a PTP stream traverses a “fixed” physical path in order to achieve high precision. However, between two network nodes that implement the LAG, packets may be transmitted through different paths. Embodiments of invention provide a static physical transport path for the PTP stream.

PTP-LAG port engine—an instance of a PTP protocol engine running on a line card processor to manage a member port of a PTP-port group. According to the IEEE 1588 protocol, a PTP protocol engine is a software entity that provides PTP message exchange between a local PTP clock and remote PTP clocks.

Active PTP-LAG port (or active port)—A member port of a PTP-port group that is used for PTP message distribution for a concerned PTP stream. Note that activeness is associated with a specific PTP stream only, that is; an active PTP-LAG port P1 for PTP stream S1 may not be active for PTP stream S2.

Standby PTP-LAG port—A member port of a PTP-port group that is not active in PTP message distribution for the concerned PTP stream.

Embodiments of the invention expand the single PTP port concept defined in the IEEE 1588 protocol across all the ports in a LAG to form a PTP-port group. From the viewpoint of an external network node, the PTP-port group is one logical instance with a single PTP port identifier for all the member ports. There may, however, exists multiple PTP streams on the same LAG, each corresponding to a separate PTP-port group and therefore a separate PTP stream. For simplicity of the discussion, the description herein is limited to the scenario in which there is one PTP-port group per LAG.

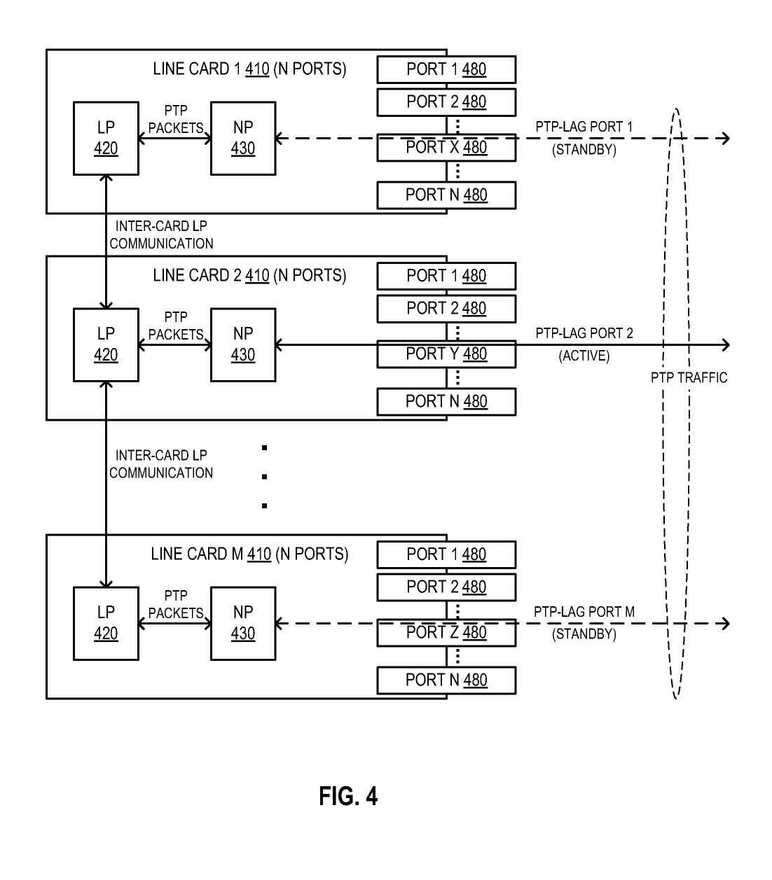

FIG. 4 illustrates an embodiment of a LAG that spans across M physical ports of a network node (e.g., the network node 110 of FIG. 2), one on each line card 410. In alternative embodiments, some line cards 410 may contain more than one member ports of a LAG while some line cards 410 contain none of the member ports of the LAG. In one embodiment, each physical port may be an Ethernet port for transporting Ethernet traffic.

In one embodiment, each line card 410 contains a network processor (NP) 430 and a line card (LP) processor 420, although in some embodiments a single processor may be used to perform the functions of the NP 430 and the LP 420. In one embodiment, when one of the NPs 430 (e.g., the NP430 on Line Card 1) detects the reception of PTP messages from one of its ports 480 (the ports that are also on Line Card 1), the NP 430 forwards the messages to its LP 420 (on Line Card 1) for processing by the PTP-LAG port engine. The NP 430 also distributes the PTP port identifier of the port that received the PTP messages to all of the other PTP-LAG port engines that manage the other member ports of the LAG. By distributing the PTP port identifier to all these PTP-LAG port engines, all of the ports in the PTP-port group become aware of the associated PTP stream inside the PTP port. PTP-LAG ports under the same PTP-port group work as a single entity.

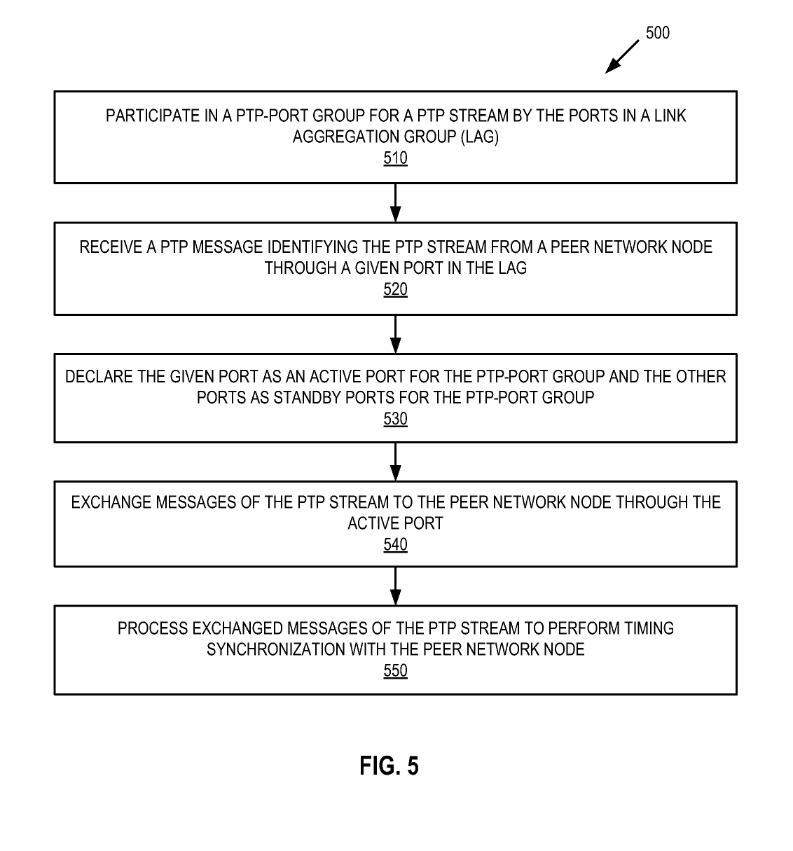

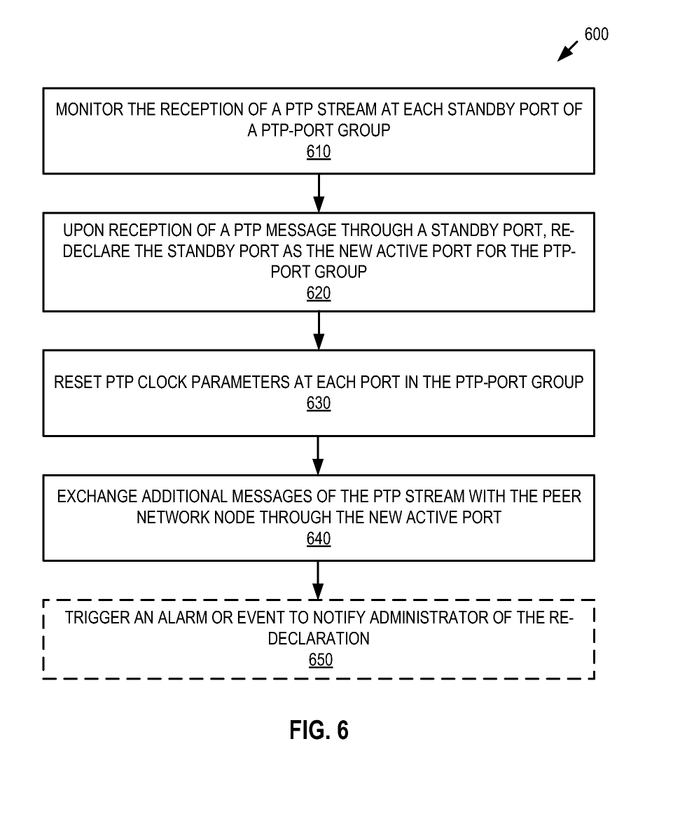

In the following, a clock start procedure is described with reference to FIG. 5, and a clock re-declaration procedure is described with reference to FIG. 6.

FIG. 5 illustrates an embodiment of a method 500 for establishing a PTP clock over a LAG. In one embodiment, the method 500 can be performed by a network node (e.g., any of the network nodes 110A-K of FIG. 1 or the network node 110 of FIG. 2).

The method 500 begins when the ports in a LAG participate in a PTP-port group for an assigned PTP stream (block 510). The formation of the PTP-port group may include initializing a PTP-LAG port engine for each PTP-LAG port to disseminate PTP configuration information to the ports. During initialization, one PTP-LAG port engine is established for each of the PTP-LAG ports. The PTP-LAG port engine receives information on configured PTP clock stream (e.g., whether the network node is a master or a slave, clock parameters, etc.), and information of all peer PTP-LAG ports in the group within the same network node.

After the initialization, all of the PTP-LAG ports stay standby and wait until a message from the assigned PTP stream is received. When the network node receives a PTP message identifying the assigned PTP stream from a peer network node through a given PTP-LAG port (block 520), it declares the given PTP-LAG port as an active port for the PTP-port group while other PTP-LAG ports stay standby for the PTP-port group (block 530). The network node exchanges messages of the PTP stream to the peer network node through the active port (block 540). The network node then processes exchanged messages of the PTP stream to perform timing synchronization with the peer network node (block 550).

There are at least two scenarios in which a PTP-LAG port of a network node receives a PTP message. In these scenarios, the key is to determine the PTP-LAG port that receives the PTP stream, as indicated by a reply to a poking message or by a received PTP message.

In one scenario (A) where the network node is configured to maintain a slave clock for the PTP stream, the network node can initiate a poking message. One of the PTP-LAG ports can be chosen arbitrarily to send out a poking message. It is immaterial which port is to transmit this poking message.

The poking message may be in various forms such as: unicast message negotiation, Sync, Delay_Req, Pdelay_Request as defined in the IEEE 1588 protocol. Upon receiving this poking message, a peer PTP clock (maintained by a peer network node) responds with a reply which will be received by one of the PTP-LAG ports corresponding to the PTP-port group of the network node.

In another scenario (B) where unicast message negotiation is not used and the network node's clock is not configured to initiate a message (e.g., the network node is maintaining the master clock), one of the PTP-LAG ports of the network node will still receive a PTP message from a peer PTP port of a peer network node as specified by the IEEE 1588 protocol. This peer network node can be, for example, another network node maintaining a slave clock in accordance with the IEEE 1588 protocol.

In the above scenarios, the PTP-LAG port which has received either the poking message's reply or a PTP protocol message will declare (via its PTP-LAG port engine) itself active to the PTP stream of the PTP-port group, and inform all the other peer PTP-LAG ports to stay standby.

Once the identifier of the physical (PTP-LAG) port is declared to be active for the PTP stream, the PTP-LAG port engine associated with the active port functions to provide PTP protocol services and handling all of the IEEE 1588 protocol messages. The standby PTP-LAG-ports for the PTP stream, however, continue to monitor if there is any message received through the standby ports for that particular clock instance. If a PTP message is received through a standby port, the standby port (more specifically, the PTP-LAG port engine associated with the standby port) will trigger a re-declaration procedure by broadcasting to all of the PTP-LAG ports its intention to become the new active port. The re-declaration trigger can be filtered to prevent the flipping of active-port state between two ports; that is, to prevent an active PTP-LAG port of a PTP stream from jumping amongst different physical ports in a short period of time, which may cause the slave clock out of lock.

Upon this clock re-declaration, the PTP clock parameters are reset to allow the PTP clock synchronization algorithm to re-converge to its new path. This change in the received PTP-LAG port can be a result of changes in routing path metric with common routing protocol such as Border Gate Protocol (BGP). An alarm or event can be triggered to notify the system administrator of the re-declaration procedure that has taken place.

FIG. 6 illustrates an embodiment of a method 600 for re-declaring a new active port. In one embodiment, the method 600 can be performed by a network node (e.g., any of the network nodes 110A-K of FIG. 1 or the network node 110 of FIG. 2).

The method 600 begins with the network node monitoring the reception of a PTP stream at each standby port of a PTP-port group (block 610). Upon reception of a PTP message through a standby port, the network node re-declares the standby port as the new active port for the PTP-port group (block 620). The network node resets PTP clock parameters of each of the PTP-LAG ports in the PTP-port group (block 630). The network node then exchanges additional messages of the PTP stream with the peer network node through the new active port (block 640). In some embodiment, an alarm or event is triggered to notify a system administrator of the re-declaration of the clock (block 650).

The operations of the diagrams of FIGS. 5 and 6 have been described with reference to the exemplary embodiments of FIG. 1 and FIG. 2. However, it should be understood that the operations of the diagrams of FIGS. 5 and 6 can be performed by embodiments of the invention other than those discussed with reference to FIG. 1 and FIG. 2, and the embodiments discussed with reference to FIG. 1 and FIG. 2 can perform operations different than those discussed with reference to the diagrams of FIGS. 5 and 6. While the diagrams of FIGS. 5 and 6 show a particular order of operations performed by certain embodiments of the invention, it should be understood that such order is exemplary (e.g., alternative embodiments may perform the operations in a different order, combine certain operations, overlap certain operations, etc.).

Different embodiments of the invention may be implemented using different combinations of software, firmware, and/or hardware. Thus, the techniques shown in the figures can be implemented using code and data stored and executed on one or more electronic devices (e.g., an end station, a network node). Such electronic devices store and transmit (internally and/or with other electronic devices over a network) code (composed of software instructions) and data using computer-readable media, such as non-transitory tangible computer-readable media (e.g., computer-readable storage media such as magnetic disks; optical disks; read only memory; flash memory devices) and transitory computer-readable transmission media (e.g., electrical, optical, acoustical or other form of propagated signals—such as carrier waves, infrared signals). In addition, such electronic devices typically include a set of one or more processors coupled to one or more other components, such as one or more non-transitory machine-readable media (to store code and/or data), user input/output devices (e.g., a keyboard, a touchscreen, and/or a display), and network connections (to transmit code and/or data using propagating signals). The coupling of the set of processors and other components is typically through one or more busses and bridges (also termed as bus controllers). Thus, a non-transitory computer-readable medium of a given electronic device typically stores instructions for execution on one or more processors of that electronic device. One or more parts of an embodiment of the invention may be implemented using different combinations of software, firmware, and/or hardware.

As used herein, a network node (e.g., a router, switch, bridge, controller) is a piece of networking equipment, including hardware and software, that communicatively interconnects other equipment on the network (e.g., other network nodes, end stations). Some network nodes are “multiple services network nodes” that provide support for multiple networking functions (e.g., routing, bridging, switching, Layer 2 aggregation, session border control, Quality of Service, and/or subscriber management), and/or provide support for multiple application services (e.g., data, voice, and video).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method performed by a network node for implementing the IEEE 1558 Precision Timing Protocol (PTP) over a Link Aggregation Group (LAG) formed by multiple ports of the network node, wherein the ports in the LAG are coupled to a peer network node via respective links that form a single logical transport pipe to improve load balancing and to provide redundancy, the method comprising the steps of:
participating in a PTP-port group for a PTP stream by the ports in the LAG;
receiving a PTP message that identifies the PTP stream from the peer network node through a given one of the ports in the LAG;
declaring to other ports in the LAG upon reception of the PTP message that the given port is an active port for the PTP-port group and the other ports are standby ports for the PTP-port group;
exchanging messages of the PTP stream to the peer network node through the active port, wherein the PTP stream is transmitted from the network node to the peer network node through the active port only and not through any of the standby ports to maintain symmetry of the PTP stream's transmission paths between the network node and the peer network node; and
processing exchanged messages of the PTP stream to perform timing synchronization with the peer network node.

2. The method of claim 1, wherein the step of forming further comprises the steps of:
initializing a PTP-LAG port engine for each of the ports in the LAG to form the PTP-port group; and
disseminating PTP configuration information from the PTP-LAG port engine to each of the ports in the PTP-port group.

3. The method of claim 1, wherein the method further comprises the steps of:
monitoring reception of the PTP stream at each of the standby ports; and
re-declaring a given one of the standby ports as a new active port for the PTP-port group upon the reception of the PTP stream through the given standby port.

4. The method of claim 3, wherein the method further comprises the step of:
resetting PTP clock parameters at each of the ports in the PTP-port group after re-declaration of the new active port.

5. The method of claim 3, wherein the method further comprises the steps of:
broadcasting to each of the ports in the PTP-port group that the given standby port has become the new active port; and
exchanging additional messages of the PTP stream with the peer network node through the new active port.

6. The method of claim 3, wherein the method further comprises the step of:
triggering an alarm or event to notify an administrator of re-declaration of the new active port.

7. The method of claim 1, wherein prior to receiving the PTP message that identifies the PTP stream from the peer network node, the method further comprises the step of:
sending an initial message from the network node to the peer network node to solicit a reply.

8. The method of claim 1, wherein the network node is a master node in accordance with the PTP.

9. The method of claim 1, wherein the network node is a slave node in accordance with the PTP.

10. The method of claim 1, wherein the network node is a router.

11. A network node that implements the IEEE 1558 Precision Timing Protocol (PTP) over a Link Aggregation Group (LAG) formed by multiple ports of the network node, wherein the ports in the LAG are coupled to a peer network node via respective links that form a single logical transport pipe to improve load balancing and to provide redundancy, the network node comprising:
a plurality of line cards, wherein the ports in the LAG spread over one or more of the line cards, and wherein each of the one or more line cards comprising:
receiver circuitry to receive a PTP message that identifies a PTP stream from the peer network node through a given one of the ports in the LAG;
transmitter circuitry to transmit messages of the PTP stream; and
a processor coupled to the receiver circuitry and the transmitter circuitry, the processor configured to:
participate in a PTP-port group for the PTP stream by the ports in the LAG;
declare to other ports in the LAG upon reception of the PTP message that the given port is an active port for the PTP-port group and the other ports are standby ports for the PTP-port group;
exchange the messages of the PTP stream to the peer network node through the active port only and not through any of the standby ports to maintain symmetry of the PTP stream's transmission paths between the network node and the peer network node; and
process exchanged messages of the PTP stream to perform timing synchronization with the peer network node.

12. The network node of claim 11, wherein the processor is further configured to initialize a PTP-LAG port engine for each of the ports in the LAG to form the PTP-port group, and disseminate PTP configuration information from the PTP-LAG port engine to each of the ports in the PTP-port group.

13. The network node of claim 11, wherein the processor is further configured to monitor reception of the PTP stream at each of the standby ports, and re-declare a given one of the standby ports as a new active port for the PTP-port group upon the reception of the PTP stream through the given standby port.

14. The network node of claim 13, wherein the processor is further configured to reset PTP clock parameters at each of the ports in the PTP-port group after re-declaration of the new active port.

15. The network node of claim 13, wherein the processor is further configured to broadcast to each of the ports in the PTP-port group that the given standby port has become the new active port and exchange additional messages of the PTP stream with the peer network node through the new active port.

16. The network node of claim 13, wherein the processor is further configured to trigger an alarm or event to notify an administrator of re-declaration of the new active port.

17. The network node of claim 11, wherein prior to receiving the PTP message that identifies the PTP stream from the peer network node, the processor is further configured to send an initial message from the network node to the peer network node to solicit a reply.

18. The network node of claim 11, wherein the network node is a master node in accordance with the PTP.

19. The network node of claim 11, wherein the network node is a slave node in accordance with the PTP.

20. The network node of claim 11, wherein the network node is a router.
